(19) United States
(12) Patent Application Publication
(10) Pub. No.: US 2008/0177450 A1
(43) Pub. Date: Jul. 24, 2008

(54) Ground Engineering Apparatus and Method

(76) Inventor: Dave Daniel, Dorset (GB)

Correspondence Address: DICKSTEIN SHAPIRO LLP, 1825 EYE STREET NW, Washington, DC, 20006-5403, US

(21) Appl. No.: 11/795,877

(22) PCT Filed: Jan. 9, 2006
(86) PCT No.: PCT/GB2006/000068

§ 371 Date: Oct. 17, 2007

(30) Foreign Application Priority Data
Jan. 24, 2005 (GB) 0501488.1

(51) Int. Cl. G06F 19/00; G05D 1/00

(52) U.S. Cl. 701/50

(57) ABSTRACT

A method is disclosed of controlling a ground engineering apparatus including an elongate member for creating a bore at a predetermined position and orientation. The method includes receiving a plurality of positional information signals relating to the apparatus, processing the positional information signals to generate positional data including a representation of the position and orientation of the elongate member relative to the predetermined position and orientation of the bore; and outputting a control signal for aligning the elongate member with the predetermined position and orientation of the bore. A ground engineering apparatus, computer apparatus, drilling rig and piling rig are also disclosed.

The present invention relates to a ground engineering apparatus and a method of controlling a ground engineering apparatus. The invention has particular application in the field of drilling and piling rigs.

During the construction of roads, for example, it is often required to build over relatively soft ground, such as clay, sands and shingle, which ground would not normally be able to provide a stable and sufficient support for the road surface and any traffic passing over it. To provide the necessary support, it is customary to insert a plurality of piles into the ground in a grid-like formation, so as to provide rigid anchors for the road surface or other structure above.

In moderately soft ground, piles may be formed by driving resilient members (such as long steel rods) into the ground, for example by repeatedly dropping a heavy weight (known as a ‘monkey’) onto the top of the pile so as to drive it in, or by constantly applying pressure to the top of the pile by gripping adjacent piles and applying a force between them and the pile to be driven. In very soft ground, piles may be formed by drilling into the ground with a drilling rig and backfilling with a resilient material as the drill is removed. Such techniques are also used in other situations, for example to create foundations of large buildings.

Customarily, when a series of piles are to be formed, a survey of the entire site is conducted, and a series of wooden pegs are placed in the ground at positions where a bore (such as a substantially cylindrical or other relatively long and thin-shaped shaft, or a substantially helical cavity in the shape of a drill bit, and so on) is required to be created in order to form or insert a pile. This process of marking out the site with pegs is typically done using conventional surveying techniques, usually requiring at least two surveyors to locate and mark out the positions.

This process can be time-consuming and inefficient, however, and it can be difficult for surveyors to mark out the site when the ground is very soft. Furthermore, piling and drilling rigs typically have a tall drilling or piling mast, which may sometimes be required to operate at an angle (for example if the ground is uneven), and it can be difficult for the operator of the piling or drilling rig to determine if he has located the rig in the correct position to create a bore at the correct position and orientation.

In view of these and other problems identified with conventional ground engineering methods, there is in a first aspect of the invention provided a method of controlling a ground engineering apparatus, the apparatus including an elongate member for creating a bore at a predetermined position and orientation, and the method comprising: receiving a plurality of positional information signals relating to the apparatus; processing the positional information signals to generate positional data including a representation of the position and orientation of the elongate member relative to the predetermined position and orientation of the bore; and outputting a control signal for aligning the elongate member with the predetermined position and orientation of the bore.

The term ‘ground’ as used herein preferably refers to any surface or substance in which the bore is desired to be created and may, for example, include man-made or natural material at any inclination to the horizontal (such as a substantially vertical inclination, for example). The term ‘positional data’ may comprise data representing any number of relative or absolute Cartesian or other co-ordinates and/or rotations, for example. The term ‘elongate member’ preferably refers to a drilling or piling mast or similar structure, and may include elements used for creating a bore (such as a drill bit or shaft) as well as structural elements (such as a support mast). The positional information signals may be, for example, global positioning system (GPS) signals, radio frequency signals, visible light signals, or laser beams as used in ‘total station’ positioning systems and the like. The positional information signals may also be output by devices for receiving such signals; the positional information signals may for example be signals output by GPS receivers and electronic compasses and the like.

By determining the relative position and orientation of the elongate member and the predetermined position and orientation of the bore in dependence on positional information signals relating to the apparatus, and outputting a control signal for aligning the elongate member with the bore position and orientation, there is no need to mark out a site. Thus the physical requirements (such as wooden pegs) can be reduced, and time can be saved. Furthermore, by providing an output signal for aligning the elongate member (such as the drilling or piling mast), which signal can be made directly available to the operator of the apparatus, the accuracy of the apparatus can be improved (compared, for example, to the previous situation where the operator may have had to visually estimate the target point of the apparatus).

The elongate member may consist of a portion (including, for example, the ‘operative’ part of the member for creating the bore, such as a drill bit or a strike point of a pile driver) which, in use, is proximate to the ground and a distal portion (including, for example, the top of a drilling or piling support mast, well away from the point on which the apparatus operates), and the processing step comprises determining the position of the proximate portion of the elongate member. This can increase the accuracy of alignment, since it is the proximate portion of the elongate member which is usually required to be in closest alignment with the position of the bore to be created.

At least one of the positional information signals may relate to the position of a location other than the proximate portion of the elongate member, such as at a location on the distal portion of the elongate member. This can avoid damage to the receivers or a loss of accuracy due to close proximity with the ‘operative’ portion of the elongate member (the damage or loss of accuracy arising, for example, from vibrations or from material ejected from the bore). By locating a receiver at the distal portion of the elongate member, typically the highest point of the apparatus, reception of signals (especially global positioning signals) can be improved, for example.

The processing step may further comprise applying the positional data to a model of the apparatus to compute the position of the proximate portion of the elongate member. Thus the system can be applied to different apparatus by providing appropriately modified models. Dynamically changing models may also be used, for example, further to increase the flexibility of the system.

The elongate member may be independently movable with respect to another part of the apparatus, and the method may further comprise receiving measurement data relating to the relative position of the elongate member with respect to the remainder of the apparatus, and processing the positional information signals in dependence on the measurement data. The measurement data may include a representation of at least one of an angular measurement (corresponding to a measurement of degrees or radians, for example) or a distance measurement (corresponding to the relative extension of one part of the member with respect to another, which may be a positive or negative measurement of relative length, for example). The elongate member may also be independently moveable in more than one respect, with a corresponding further number of measurements being taken as appropriate. Thus the system can, for example, align a drilling or piling mast with a bore location without requiring the drilling or piling mast to be in any particular orientation or position.

The positional information signals may relate to a measurement of the position of a predetermined location on the apparatus and a measurement of the orientation of the apparatus about a predetermined axis, or it may relate to a measurement of the positions of two predetermined locations on the apparatus, the method then further comprising determining the orientation of the apparatus about a predetermined axis in dependence on the two positions of the respective predetermined locations. The orientation of the apparatus about a predetermined axis may, for example, be a compass bearing of the apparatus, or the like. Thus, the position and orientation of the apparatus can be determined either with or without a compass-like device, and with only one set of essentially instantaneous readings.

The method may further comprise selecting the predetermined position of the bore to be created from a list of a plurality of predetermined positions of bores to be created. The list of positions may be provided as a text file or other input, and may be stored temporarily or permanently at the apparatus or associated data processing device. The selection may be made of the bore which is determined to be the nearest to the apparatus at the time of selection, so as to allow the set of bores to be created in an efficient manner. The list of bores may, for example, be updated during the process of creating new bores, for example to take into account a deviation in the location of a bore, allowing greater flexibility than the marking out system. The operator may also initiate or override the bore selection process, for example.

The control signal may include at least one of a direction in which the apparatus should be moved, a distance through which the apparatus should be moved, a direction in which the elongate member should be moved, and/or a distance through which the elongate member should be moved. Thus the control signal may provide all necessary control information to reach all of the bore locations. The method may further comprise outputting a predetermined signal when the elongate member is substantially aligned with the predetermined position of the bore. This can be a message, for example, to instruct the operator or another control system to commence creation of the bore (and forming or insertion of a pile). A tolerance may be specified, for example, on a global or per-bore basis, indicating how near to alignment the elongated member is required to be before it is considered to be aligned (or ‘locked on’) to the bore location.

The method may further comprise outputting the control signal to a display, and also may comprise outputting a representation of the apparatus (for example, plotting a model of the apparatus in 2D or 3D form, and/or illustrating the relative positions of relatively moveable parts of the apparatus, such as a drilling or piling mast), a representation of at least one predetermined position of a bore to be created (for example showing the position, orientation, altitude, status and other characteristics of the bore), and/or a representation of an environment in which the apparatus is located (such as a 2D or 3D representation of the terrain, for example including height contours and other features for navigation or other purposes). This may be essentially in realtime (or at least on a periodic and/or regular basis) or it may be a ‘snapshot’. Components of the system may be located at or on the apparatus, or elsewhere, connected to the apparatus by appropriate means.

The method may further comprise receiving a signal indicating that the bore has been created, and storing data in a data store to indicate that the bore has been created. This data can record, for example, minor deviations from the predetermined positions of bores for later reference, and assist in the generation of accurate site maps. The data can also maintain an accurate record of bores (and corresponding piles) remaining to be created, thus increasing the efficiency of the operation.

The method may further comprise driving at least one of the elongate member and the apparatus in dependence on the output signal, so as to allow the process of locating and creating bores to be operated with reduced operator interaction, and corresponding increased efficiency.

In a related aspect of the invention, there is provided a ground engineering apparatus, comprising: an elongate member for creating a bore at a predetermined position and orientation; at least one receiver for receiving a plurality of positional information signals; a processor for processing the positional information signals to generate positional data including a representation of the position and orientation of the elongate member relative to the predetermined position and orientation of the bore; and an output for outputting a control signal, in dependence on the processing, for aligning the elongate member with the predetermined position and orientation of the bore.

The elongate member may consist of a portion which, in use, is proximate to the ground and a distal portion, and wherein the means for processing is adapted to determine the position of the proximate portion of the elongate member. At least one receiver may be located outside the proximate portion of the elongate member (on the main body of the apparatus, near the operator cab, for example, or placed at an extremity of the apparatus), and may furthermore be located on the distal portion of the elongate member. A mounting may be provided, for example, to mount two or more receivers at an appropriate distance to allow the determined positions of the receivers to be distinguished. This mounting could be a horizontal bar attached to the top of a piling or drilling mast, for example.

The elongate member may be independently movable with respect to another part of the apparatus, the apparatus then further comprising at least one sensor for outputting measurement data relating to the relative movement of the elongate member, and the means for processing being adapted to process the positional information signals in dependence on the measurement data. The measurement data may represent an angular measurement, a distance measurement (for example from a distance sensor), or a measurement from an accelerometer or similar device, for example. The or each sensor may be inertially damped, and may for example be a pendulum sensor. This can render the sensor less sensitive to vibrations arising from activities such as drilling or piling.

The apparatus may further comprise a positioning receiver (such as a GPS receiver or similar device) for determining the position of the receiver, and a compass (such as a GPS compass, or a conventional magnetic compass or a gyroscopic device) for determining the orientation of the apparatus about a predetermined axis. Alternatively techniques such as slewing may be used to determine the orientation of the device.

The apparatus may further comprise at least one drive unit for driving at least one of the apparatus and the elongate member. The drive unit could be a motor, pneumatic, hydraulic or other drive unit capable of causing movement, extension or rotation of the apparatus or elongate member. The output may be operatively connected to the or each drive unit, and further control systems may be provided as necessary. A plurality of drive units may be provided, for example, to control the orientation of the elongate member in a plurality of directions, for example in the direction in which the apparatus is facing, and in a perpendicular direction thereto.

The apparatus may further comprise a display for displaying the control signal, and/or a data store for storing information relating to at least one bore to be created. The apparatus may include a workstation or conventional PC, or more specialised display and processing components. A keyboard, pointing or touch-screen input device may be provided, for example.

In another aspect of the invention there is provided a ground engineering apparatus, comprising: an elongate member for creating a bore at a selected position and orientation, including an inertially damped sensor for outputting measurement data representing the orientation of the elongate member; a receiver for receiving at least one positional information signal relating to the apparatus; a processor for processing the measurement data and the or each positional information signal to generate positional data representing the position and orientation of the elongate member; and an output for outputting the positional data. The inertially damped sensor may be a pendulum sensor, for example, or a solid state sensor located in an inertially damped mounting.

A software application program may be provided to undertake the processing steps as aforesaid, and to provide a graphical display containing the content of the control signal. Arrows may be displayed to indicate a direction in which the apparatus is to be moved and/or oriented, and indications may be provided of the elongate member's current and required position, orientation and/or extension.

In another aspect of the invention, there is provided a drilling rig comprising ground engineering apparatus as aforesaid.

In a further aspect of the invention, there is provided a piling rig comprising ground engineering apparatus as aforesaid.

In a yet further aspect of the invention, there is provided a computer apparatus for controlling a ground engineering apparatus, the computer apparatus comprising an instruction memory storing processor implementable instructions; a processor operable in accordance with instructions stored in the instruction memory; an input device for receiving positional information relating to the ground engineering apparatus; an output device for outputting a control signal for controlling the ground engineering apparatus; the instructions stored in the instruction memory comprising instructions for controlling the processor to carry out a method as aforesaid. A data store for storing data, comprising at least one predetermined position of a bore to be created, may also be provided.

In another aspect of the invention, there is provided a carrier medium carrying computer readable code for controlling a computer to carry out a method as aforesaid.

Aspects of the present invention can be implemented in any convenient form, for example using dedicated hardware, or a mixture of dedicated hardware and software. Since aspects of the present invention can be implemented as software, the relevant parts of each and every aspect of the present invention thus encompass computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network e.g. the Internet. The carrier medium can also comprise a storage medium for storing processor readable code such as a floppy disk, hard disk, CD ROM, magnetic tape device or solid state memory device.

Embodiments of the present invention will now be described with reference to the accompanying drawings, in which:

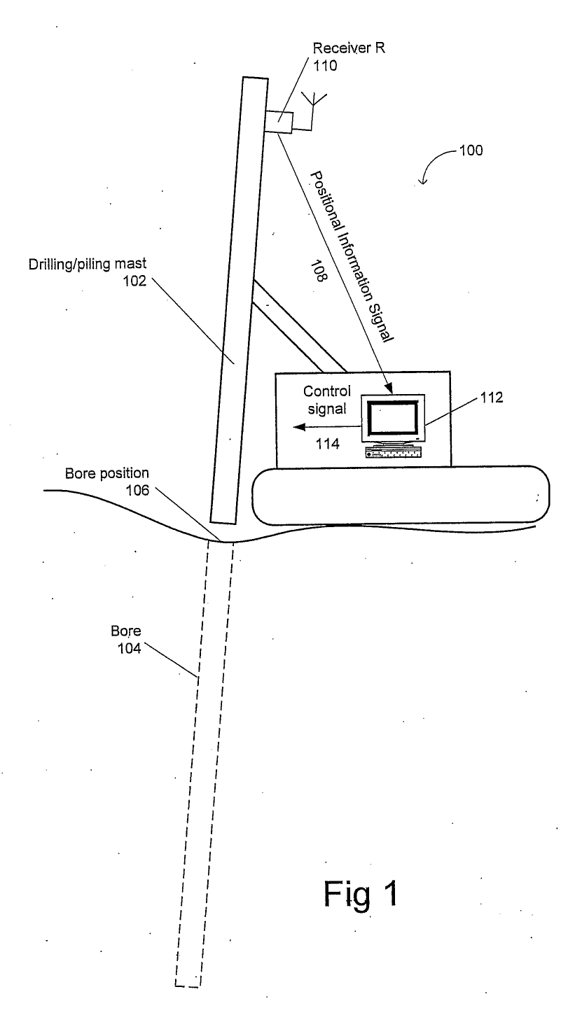

FIG. 1 is a schematic diagram of a ground engineering apparatus in accordance with the present invention;

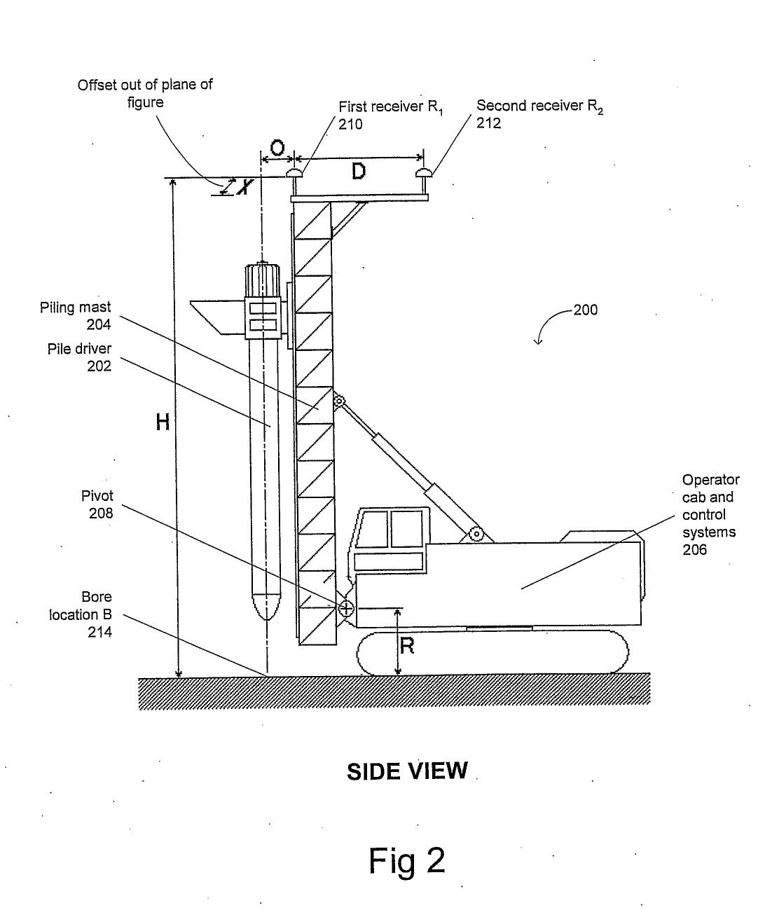

FIG. 2 is a side view of a ground engineering apparatus showing various dimensions of the apparatus;

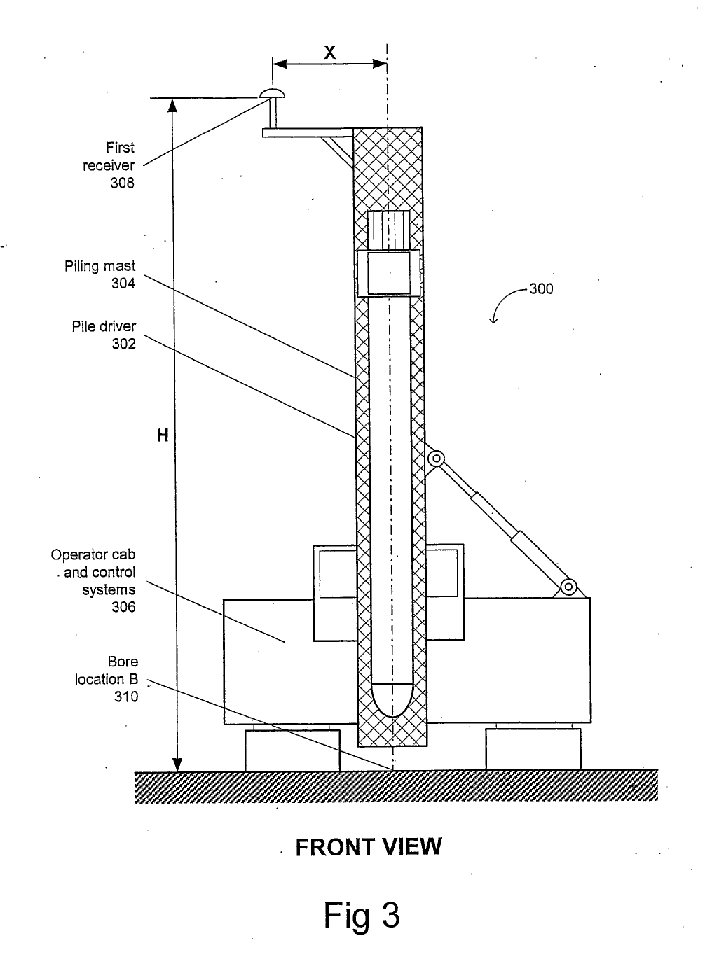

FIG. 3 is a front view of a ground engineering apparatus showing various dimensions of the apparatus;

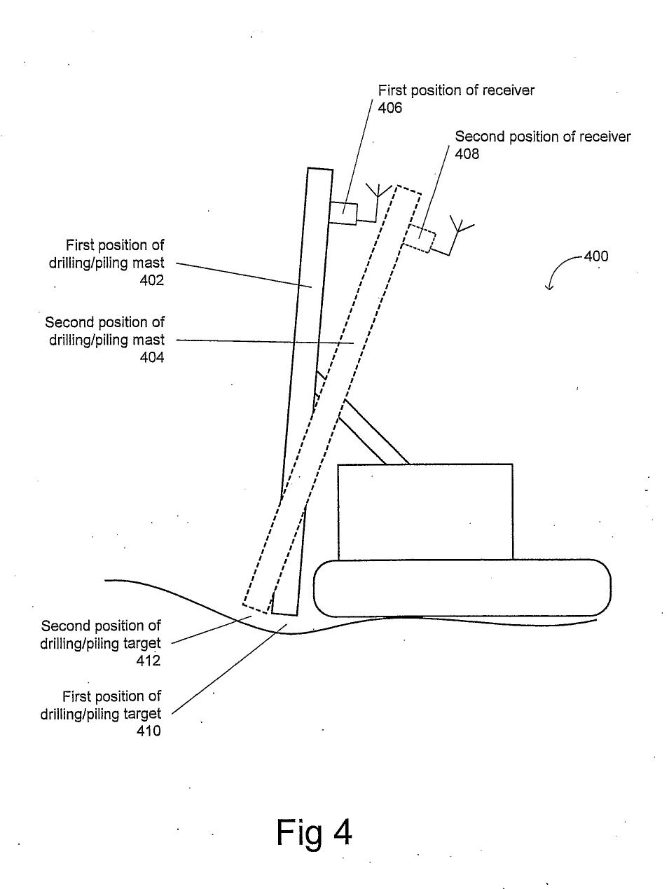

FIG. 4 is a schematic diagram illustrating different configurations of a ground engineering apparatus;

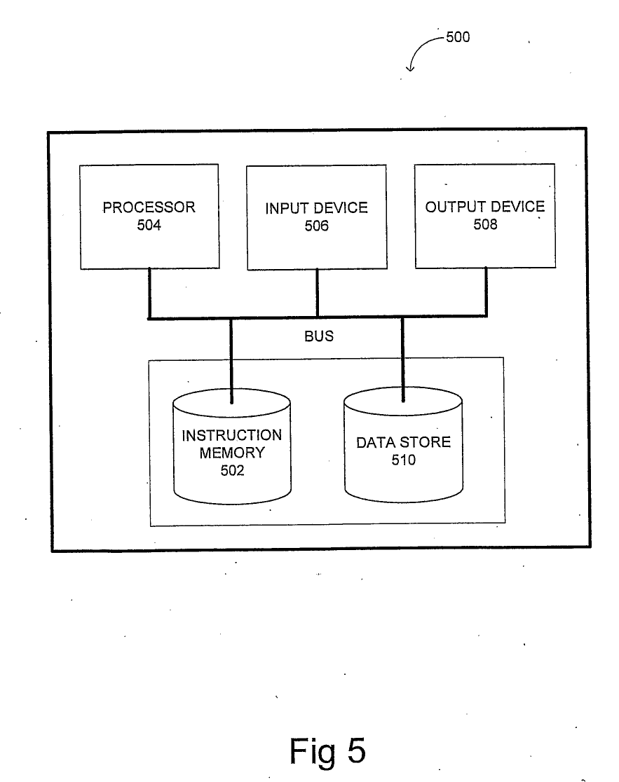

FIG. 5 is a schematic diagram of a computer apparatus for controlling a ground engineering apparatus;

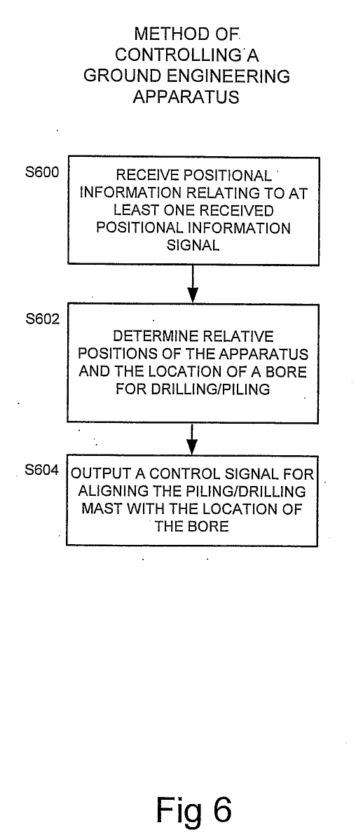

FIG. 6 is a flow diagram illustrating a method of controlling a ground engineering apparatus;

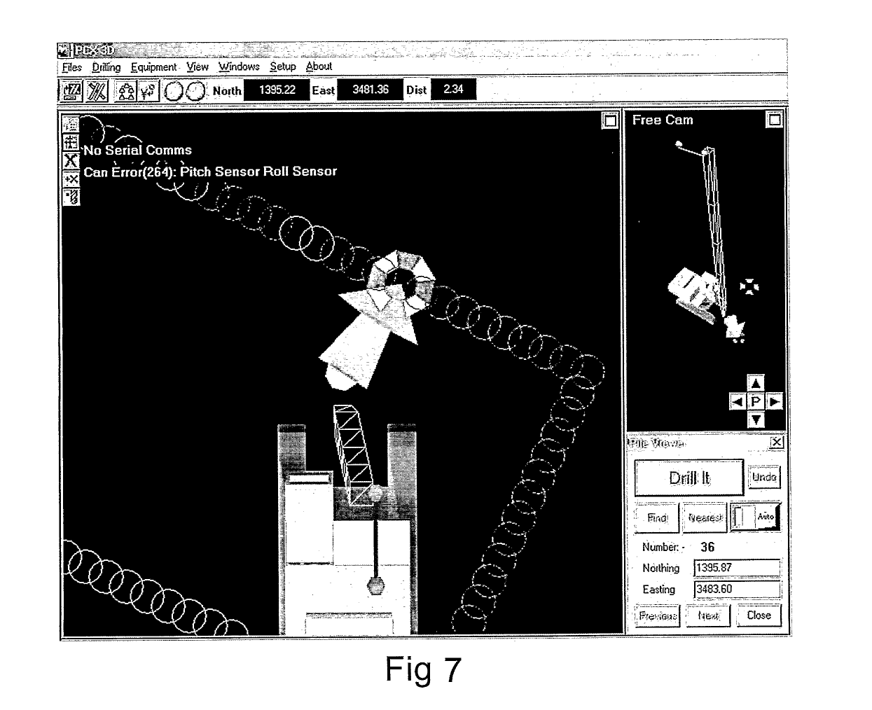

FIG. 7 is a screenshot illustrating the output of a control system for aligning the ground engineering apparatus with the location of a bore;

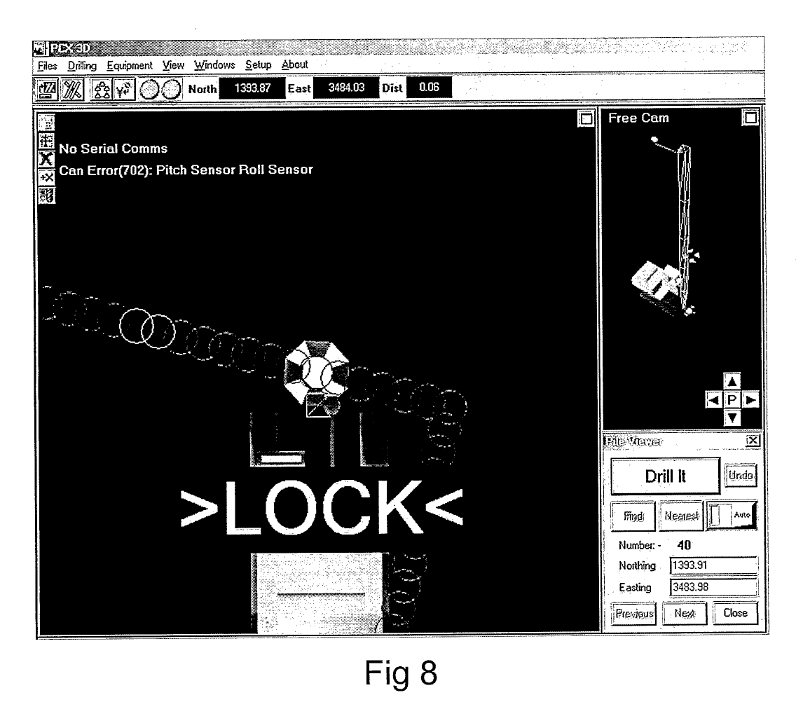

FIG. 8 is a second screenshot illustrating the output of a control system for aligning the ground engineering apparatus with the location of a bore;

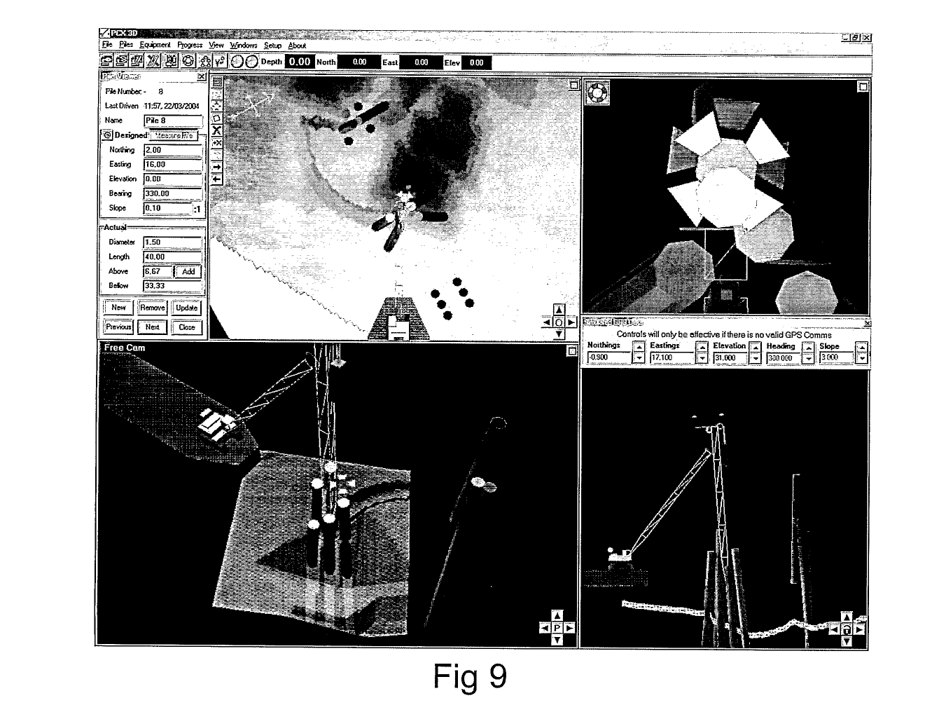

FIG. 9 is a third screenshot illustrating the output of a control system for aligning the ground engineering apparatus with the location of a bore; and

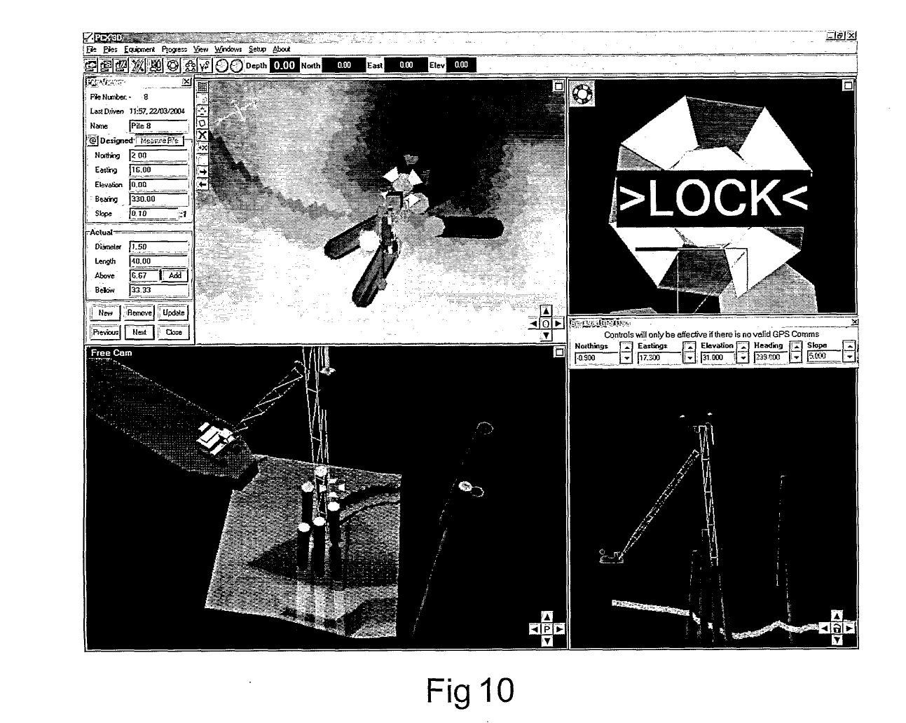

FIG. 10 is a fourth screenshot illustrating the output of a control system for aligning the ground engineering apparatus with the location of a bore.

A control system for a piling or drilling rig will now be described, with reference to the accompanying figures.

In FIG. 1, a drilling/piling rig 100 is shown, including a drilling/piling mast 102 containing the drilling/piling machinery for creating a bore 104 at a bore position 106 so as to form or insert a pile, for example. To allow alignment of the drilling/piling mast 102 with the bore position 106, a positional information signal 108 is received at a receiver 110 and passed to a computer 112 in the drilling/piling rig cabin. The positional information signal and other information is then processed by the computer 112 to produce a control signal 116 for aligning the mast with the bore position 106.

The control signal 116 contains an indication to the operator of the drilling/piling rig of a direction and distance in which the rig must be moved in order to align the rig with a bore to be created. As will be described in more detail later, the control signal 116 is displayed on a screen in the cab of the drilling/piling rig, and the operator can then operate the rig accordingly. When the rig is aligned with the predetermined bore position within an acceptable degree of error, a message is displayed to the rig operator so that he can then commence the drilling or piling operation.

FIG. 2 is a side view of a piling rig 200 which utilises the control system described above. A pile driver 202, piling support mast 204, and an operator cab and control systems 206 are provided. The mast (202, 204) is rotatable by an angle θ (not shown) from the vertical about a pivot 208 at a distance R above the ground, and also independently rotatable by an angle φ (not shown) from the vertical in a plane perpendicular to the plane of the figure. A first 210 and second 212 GPS receiver/antenna are mounted at the top of the rig, separated by a distance D, and at a total distance H above the ground. As shown, the first receiver 210 is offset from the line of action of the pile driver, located at the bore location 214, by offsets O and X across and perpendicular to the plane shown in FIG. 2, respectively.

The two receivers 210, 212 are connected to receiver/decoding units (not shown) which convert the received GPS signals into positional information (longitude, latitude and altitude information) corresponding to each receiver/antenna location. The positional information is then transmitted to a computer in the operator cab using an RS232 or similar connection.

The computer contains a mathematical model of the piling rig, specifying values of dimensions such as H, R, D, O and X mentioned above. The two measured locations are input into the model to allow the current position of the pile driver to be computed, and accordingly to determine the correction to the position which would be required in order to align it with a predetermined position (of a bore to be created by driving a pile). Techniques such as trigonometry or matrix and vector multiplication may be used to compute such information. The computer then outputs the required correction as a control signal, for display on a screen in the operator cab, to pass on the required information to the rig operator.

FIG. 3 is a front view of the piling rig 300 that is shown in side view in FIG. 2. Again, a pile driver 302, piling support mast 304, and an operator cab and control systems 306 are provided. A first GPS receiver/antenna 308 is shown, mounted at the top of the rig. A second GPS receiver/antenna (not shown) lies behind and in line with the first receiver 308, as viewed in the direction of the figure. The offset X from the vertical line of action of the pile driver 302, and the height H of the receiver/antenna 308 above the ground are shown. The bore location 310, at which the pile driver 302 will act, is also shown.

FIG. 4 illustrates a drilling/piling rig 400 with a drilling/piling mast that is rotatable relative to the rig body, so as to form bores/piles at different orientations. A first orientation of the mast 402 and a second orientation of the mast 404 are shown, with a corresponding first 406 and second 408 position of a receiver. As can be seen, the different orientations of the mast also result in a first 410 and second 412 drilling/piling target, even though the remainder of the rig is stationary.

In order to take into account the effect on the position of the receiver and on the position of the drilling/piling target of the different orientations 402, 404 of the mast, a sensor (not shown) is provided to measure the orientation of the drilling/piling mast. A pendulum sensor, providing an angular measurement with respect to the vertical, is used, and the measurement is fed into the computer and then applied to the model of the drilling/piling rig. For convenience, the CAN bus protocol is used to transmit the measurements.

A magnetically damped ‘AS8’ type pendulum-driven encoder, giving an accuracy of approximately +/−0.09 degrees and being relatively resistant to vibrations and extremes of temperature, was found to work in this context. Further sensors can be added as appropriate if further degrees of freedom of the receivers and/or drilling/piling mast are present.

For example, the above principles can be applied to a piling rig such as that described above with reference to FIGS. 2 and 3, in which the piling mast can be independently rotated around two different orthogonal axes. In the system of FIGS. 2 and 3, for example, the angles (θ,φ), which the piling mast makes with respect to the vertical in two orthogonal directions (in this case: in line with the direction the piling vehicle is facing, and perpendicular to it), are measured and then used to compute the location and orientation of the piling mast.

FIG. 5 is a schematic of the computer system 500 used to process the positional information and to output a control signal. An instruction memory 502, a processor 504, an input device 506 for receiving the positional information and other information (such as user interaction), and output device 508 for outputting the control signal (in the form of a computer display signal, for example), and a data store 510 for storing information relating to the locations and status of bores to be created, are shown.

The steps undertaken by the computer are shown in FIG. 6. In step S600, positional information (GPS coordinates), relating to at least one received positional information signal, is received. In step S602, the relative positions of the apparatus and the location of the bore are determined. In dependence on this determination, a control signal is output in step S604 for aligning the piling/drilling mast with the location of the bore. This is output to a computer screen in the operator cab in various forms, as is described in more detail below with reference to FIGS. 6 to 9.

FIGS. 6 and 7 are screenshots from a display containing various items of data relating to the drilling/piling rig, a plurality of locations of bores to be created/drilled/piled, and other information for controlling the rig.

In FIG. 7, the main display shows a 2D schematic of the rig in relation to the plurality of bores. The current bore is highlighted with a ring, and the direction of the selected bore in relation to the rig is indicated with the large arrow. The positions of the two GPS receivers/antennas used to compute the relevant positional information, and the orientation of the drilling/piling mast, are also shown on this display. The current bore is selected on the basis of being the nearest incomplete bore to the rig, but the user may override the current selection if he desires. The smaller window displays a three-dimensional representation of the model of the rig, taking into account the measurements made of the orientation (and so on) of the various components.

In FIG. 8, the operator has manoeuvred the rig, under the control of the computer output, into alignment with the position of the bore to be created. The ‘lock’ condition is determined not only on the location of the apparatus as a whole, but also on the orientation of the drilling/piling mast, where appropriate, so as to ensure that the bore is created at the correct angle. A message is shown to indicate that the drilling/boring operation may commence. This operation is performed under the control of a separate control system, which returns control to the present system once the operation is completed (although a unified control system may also be provided). A database of bore information is then updated to indicate that the given bore/pile has been completed, and a new bore/pile for creation is then selected.

FIGS. 8 and 9 are screenshots of a further control output. As before, FIG. 9 shows the output before the rig is aligned, and FIG. 10 shows the output after alignment has occurred. In FIGS. 8 and 9, a three-dimensional representation of the terrain, drilling/piling rig, locations of bores to be created, locations of bores which have been created, and representations of the current placement of piles within the various bores are all shown. Other projections, such as the side elevation shown at the bottom right of the figure, and the close-up projection at the top-right are also provided to increase the information content of the output and the overall efficiency of the operation.

Topographical data and/or data specifying the bore locations and other characteristics are imported via text files, but other forms of input may be provided. Terrain data may be sensed by sensors mounted on the rig, rather than being presupplied, for example. Bore position information is generally also presupplied, but may also be determined dynamically, for example.

As noted above, the system provides various inputs and outputs to allow interconnection with other control systems, but entirely stand-alone systems may be provided. The system may also be remotely controlled, and/or provided on hand-held or other portable units, for example.

The above control system has been described above with reference to a drilling or piling rig, but it will be apparent that the control system and other relevant features described above can be applied equally to different ground engineering and other types of machines which require a portion of the machine to be aligned with predetermined locations. The system can be used, for example, for marine piling or drilling (where manual alignment of the rig with the bore location can be more difficult) or for mining, dredging, or digging operations.

Within the field of piling, the system can also be adapted to display, select and/or record different types of piles (for example, to select a type of pile depending on the constituency and arrangement of the terrain in which it is to be driven). The selection may be manual (prepared in advance, for example), or automatic (by using appropriate heuristics).

The system described above normally operates in realtime, providing constant feedback to the system operator relating to the position of the drilling/piling rig, position of the drilling/piling mast, and desired position of the bore to be drilled/piled, and so on. The system may also be adapted to give periodic updates, or to provide information to a remote user by any suitable wireless or other network connection.

Further modifications lying within the spirit and scope of the present invention will be apparent to a skilled person in the art.

1. A method of controlling a ground engineering apparatus, the apparatus including an elongate member for creating a bore at a predetermined position and orientation, and the method comprising:
receiving a plurality of positional information signals relating to the apparatus;
processing the positional information signals to generate positional data including a representation of the position and orientation of the elongate member relative to the predetermined position and orientation of the bore; and
outputting a control signal for aligning the elongate member with the predetermined position and orientation of the bore.

2. A method according to claim 1 wherein the elongate member consists of a portion which, in use, is proximate to the ground and a distal portion, and the processing step comprises determining the position of the proximate portion of the elongate member.

3. A method according to claim 2, wherein at least one of the positional information signals relates to the position of a location other than the proximate portion of the elongate member.

4. A method according to claim 2, wherein at least one of the positional information signals relates to the position of a location on the distal portion of the elongate member.

5. A method according to claim 1, wherein the processing step further comprises applying the positional data to a model of the apparatus to compute the position of the proximate portion of the elongate member.

6. A method according to claim 1, wherein the elongate member is independently movable with respect to another part of the apparatus, and the method further comprises receiving measurement data relating to the relative position of the elongate member with respect to the remainder of the apparatus, and processing the positional information signals in dependence on the measurement data.

7. A method according to claim 6, wherein the measurement data includes a representation of at least one of an angular measurement or a distance measurement.

8. A method according to claim 1, wherein the positional information signals relate to a measurement of the position of a predetermined location on the apparatus and a measurement of the orientation of the apparatus about a predetermined axis.

9. A method according to claim 1, wherein the positional information signals relate to measurements of the position of two predetermined locations on the apparatus, and the method further comprises determining the orientation of the apparatus about a predetermined axis in dependence on the two positions of the respective predetermined locations.

10. A method according to claim 1, wherein at least one of the positional information signals is received from a positioning receiver.

11. A method according to claim 1, wherein at least one of the positional information signals is received from a compass.

12. A method according to claim 1, further comprising selecting the predetermined position of the bore to be created from a list of a plurality of predetermined positions of bores to be created.

13. A method according to claim 1, wherein the control signal includes at least one of a direction in which the apparatus should be moved, a distance through which the apparatus should be moved, a direction in which the elongate member should be moved, and a distance through which the elongate member should be moved.

14. A method according to claim 1, further comprising outputting a predetermined signal when the elongate member is substantially aligned with the predetermined position of the bore.

15. A method according to claim 1, further comprising outputting the control signal to a display.

16. A method according to claim 1, further comprising outputting a representation of the apparatus.

17. A method according to claim 1, further comprising outputting a representation of at least one predetermined position of a bore to be created.

18. A method according to claim 1, further comprising outputting a representation of an environment in which the apparatus is located.

19. A method according to claim 1, further comprising receiving a signal indicating that the bore has been created, and storing data in a data store to indicate that the bore has been created.

20. A method according to claim 1, further comprising driving at least one of the elongate member and the apparatus in dependence on the output signal.

21. A method according to claim 1, further comprising forming the bore by drilling or driving a pile.

22. A ground engineering apparatus, comprising:
an elongate member for creating a bore at a predetermined position and orientation;
at least one receiver for receiving a plurality of positional information signals;
a processor for processing the positional information signals to generate positional data including a representation of the position and orientation of the elongate member relative to the predetermined position and orientation of the bore; and
an output for outputting a control signal, in dependence on the processing, for aligning the elongate member with the predetermined position and orientation of the bore.

23. Ground engineering apparatus according to claim 22, wherein the elongate member consists of a portion which, in use, is proximate to the ground and a distal portion, and wherein the means for processing is adapted to determine the position of the proximate portion of the elongate member.

24. Ground engineering apparatus according to claim 23, wherein at least one said receiver is located outside the proximate portion of the elongate member.

25. Ground engineering apparatus according to claim 23, wherein at least one said receiver is located on the distal portion of the elongate member.

26. Ground engineering apparatus according to claim 23, wherein the means for processing is adapted to apply the positional data to a model of the apparatus to compute the position of the proximate end of the elongate member.

27. Ground engineering apparatus according to claim 22, wherein the elongate member is independently movable with respect to another part of the apparatus, the apparatus further comprises at least one sensor for outputting measurement data relating to the relative movement of the elongate member with respect to the remainder of the apparatus, and the means for processing is adapted to process the positional information signals in dependence on the measurement data.

28. Ground engineering apparatus according to claim 27, wherein the measurement data includes a representation of at least one of an angular measurement or a distance measurement.

29. Ground engineering apparatus according to claim 27, wherein at least one said sensor is a pendulum sensor.

30. Ground engineering apparatus according to claim 22, further comprising a positioning receiver for determining the position of the receiver, and a compass for determining the orientation of the apparatus about a predetermined axis.

31. Ground engineering apparatus according to claim 22, comprising a plurality of positioning receivers for determining the position of each respective receiver, and wherein means for processing is adapted to determine the orientation of the apparatus about a predetermined axis in dependence on the determined positions of the receivers.

32. Ground engineering apparatus according to claim 22, further comprising at least one drive unit for driving at least one of the apparatus and the elongate member.

33. Ground engineering apparatus according to claim 32, wherein the output is operatively connected to the or each drive unit.

34. Ground engineering apparatus according to claim 22, further comprising a display for displaying the control signal.

35. Ground engineering apparatus according to claim 22, further comprising a data store for storing information relating to at least one bore to be created.

36. Ground engineering apparatus, comprising:
an elongate member for creating a bore at a selected position and orientation, including an inertially damped sensor for outputting measurement data representing the orientation of the elongate member;
a receiver for receiving at least one positional information signal relating to the apparatus;
a processor for processing the measurement data and the or each positional information signal to generate positional data representing the position and orientation of the elongate member; and
an output for outputting the positional data.

37. A drilling rig comprising ground engineering apparatus as claimed in claim 22, the elongate member being adapted to drill the bore.

38. A piling rig comprising ground engineering apparatus as claimed in claim 22, the elongate member being adapted to form the bore by driving a pile.

39. A computer apparatus for controlling a ground engineering apparatus, the computer apparatus comprising:
an instruction memory storing processor implementable instructions;
a processor operable in accordance with instructions stored in the instruction memory;
an input device for receiving positional information relating to the ground engineering apparatus; and
an output device for outputting a control signal for controlling the ground engineering apparatus;
wherein the instructions stored in the instruction memory comprise instructions for controlling the processor to carry out the method of claim 1.

40. A carrier medium carrying computer readable code for controlling a computer to carry out the method of any one of claim 1.
